(19) United States
(12) Patent Application Publication
(10) Pub. No.: US 2006/0230686 A1
(43) Pub. Date: Oct. 19, 2006

(54) Sealing strip for a closure member

(75) Inventors: Achim Plum, Viersen (DE); Reimund Plottnik, Nettetal (DE); Sandro Wartzack, Hallstadt (DE)

Correspondence Address: LEYDIG VOIT & MAYER, LTD, 700 THIRTEENTH ST. NW, SUITE 300, WASHINGTON, DC, 20005-3960, US

(73) Assignee: GDX North America Inc, Dover, DE (US)

(21) Appl. No.: 10/559,972

(22) PCT Filed: Jun. 10, 2004
(86) PCT No.: PCT/IB04/01897

§ 371 Date: Apr. 7, 2006

(30) Foreign Application Priority Data
Jun. 10, 2003 (GB) 03133642
Jun. 16, 2003 (GB) 03139425

(51) Int. Cl. E06B 7/16; E06B 7/22

(52) U.S. Cl. 49/498.1; 49/489.1; 49/493.1

(57) ABSTRACT

A car door comprises an outer part 1 and an inner part 3 which are coupled together by a fixing screw 21 and retainer 23. A sealing strip 7 is fitted over a terminal portion 15 of the inner door part 3 by means of adhesive tape 17. The fixing screw 21 is fitted by distorting or compressing the tubular portion 9 of the seal which brings aperture 31 into alignment with the aperture 22 through which the screw 21 is to pass. When the screw 21 has been fitted into the aperture 22, the tubular part 9 of the seal 7 is released and resiles. The fixing screw 21 serves to provide an additional means for locating the seal 7 and secures the inner door part 3 to the outer door part 1. A concealing lip 25 extending integrally from the tubular part 9 of the seal 7 conceals from view the point where the outer door part 1 and the inner door part 3 are joined together to improve the visual appearance of the door and to reduce or prevent dirt or moisture entering the space between the outer and inner door parts 1 and 3.

### TECHNICAL FIELD

The present invention relates to a sealing strip for a closure member, such as a vehicle door, and which seals between the closure member and the frame of an aperture closed by the closure member, such as the frame for the door in the vehicle body shell. The present invention also relates to a closure member provided with such a sealing strip.

### DISCLOSURE OF INVENTION

According to a first aspect of the present invention, there is provided a sealing strip for a closure member, the closure member comprising a first part and a second part, the strip being configured for mounting on the closure member to seal between the closure member and the frame of an aperture closed by the closure member and for obscuring from view a connection region between the first part and the second part of the closure member.

According to a second aspect of the present invention, there is provided a closure member comprising first and second parts and means for coupling together the first and second parts, wherein a sealing strip is provided on the closure member to seal between the closure member and the frame of an aperture closed by the closure member and for obscuring from view a connection region between the first part and the second part of the closure member.

According to a third aspect of the present invention, there is provided a method of mounting a sealing strip to a closure member comprising first and second parts, the method including:
(1) coupling together the first and second parts, and
(2) mounting the seal on the closure member to seal between the closure member and the frame of an aperture closed by the closure member and for obscuring from view a connection region between the first part and the second part of the closure member,
   wherein steps (1) and (2) are performed in any order.

### BRIEF DESCRIPTION OF THE DRAWINGS

For a better understanding of the present invention a sealing strip and a closure member provided with a sealing strip will now be provided by way of example with reference to the accompanying drawings in which:

FIG. 1 shows a perspective view of inner and outer parts of a car door;

FIG. 2 shows a cross-sectional view of part of the door and a sealing strip deformed to allow attachment of the inner and outer parts of the car door;

FIG. 3 shows the sealing strip and door of FIG. 2 after attachment of the inner and outer parts of the door;

FIG. 3a shows in cross-section a modification to the FIG. 2 and 3 embodiment;

FIG. 3b shows in cross-section a further modification to the FIG. 2 and 3 embodiment;

FIG. 4 shows in cross-section a second embodiment of the sealing strip;

FIG. 4a shows an overhead view of the base of the sealing strip of FIG. 4;

FIGS. 5 and 5a show a cross-section of a third embodiment of the sealing stripl;

FIG. 6 shows in cross-section an alternative arrangement to that of FIGS. 5 and 5a;

FIG. 7 shows in cross-section a fourth embodiment of the seal;

FIG. 8 shows in cross-section a fifth embodiment of the seal;

FIG. 9 shows in cross-section an alternative arrangement to that of FIG. 8;

FIGS. 10 and 10a show in cross-section and side elevation, respectively, a sixth embodiment of the seal;

FIG. 11 shows in cross-section a seventh embodiment of the seal;

FIG. 12 shows in cross-section a eighth embodiment of the seal;

FIGS. 12a and 12b show in cross-section and side elevation, respectively, a modification of the eighth embodiment;

FIG. 13 shows in cross-section a further modification of the eighth embodiment;

FIG. 14 shows in cross-section a modification of the seventh embodiment;

FIGS. 15 and 16 show in cross-section a ninth embodiment of the seal;

FIGS. 15a and 15b show in cross-section a modification to the FIG. 15 and 16 embodiment;

FIG. 17 shows in cross-section a further modification to the FIG. 15 and 16 embodiment;

FIG. 18a, b show cross-sectional view taken along lines B-B and A-A of FIG. 18c and show a tenth embodiment;

FIGS. 19 and 20 show in cross-section an eleventh embodiment;

FIG. 21 shows in cross-section a modification of the eleventh embodiment; and

FIG. 22A, B, C show in cross-section a twelfth embodiment.

### MODES OF CARRYING OUT THE INVENTION

In the drawings like elements are generally designated with the same reference signs.

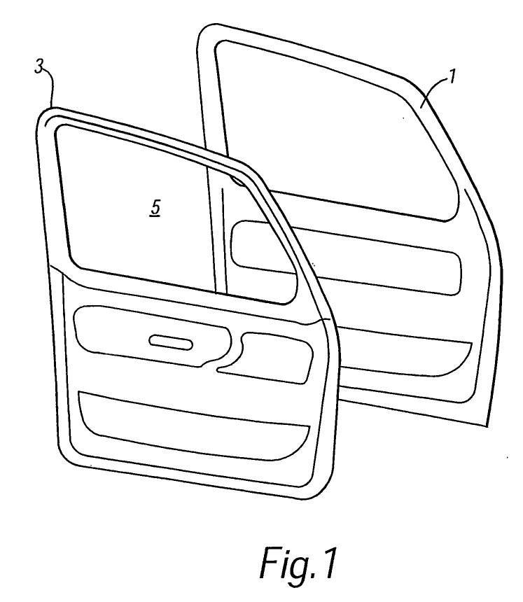

FIG. 1 shows a perspective view of a first, outer part 1 of a car door and a second, inner part 3 of the door. The outer part 1 of the door comprises the surface of the door seen from the exterior of the car. The inner part 3 of the door could be a frame formed of metal, or possibly moulded plastics, and onto or into which the movable window glass 5 is fitted together with other components, such as a switch, motor and control circuit for allowing movement of the window 5; assemblies for allowing the door to be locked; loud speakers; and the like. An inner part 3 formed in this way can be advantageous because the inner part 3 of the door can be prepared away from the main production line of the car and can be fitted to the inner part 1 of the door on the production line in a quick and simple operation, saving a considerable amount of time in comparison with prior methods of door assembly which require the inner part 3, the window 5 and the various other associated components to be fitted separately on the main car production line.

The outer part 1 of the door may itself comprise more than one part, and the construction of the outer part 1 will be better understood with reference to the embodiments to be described.

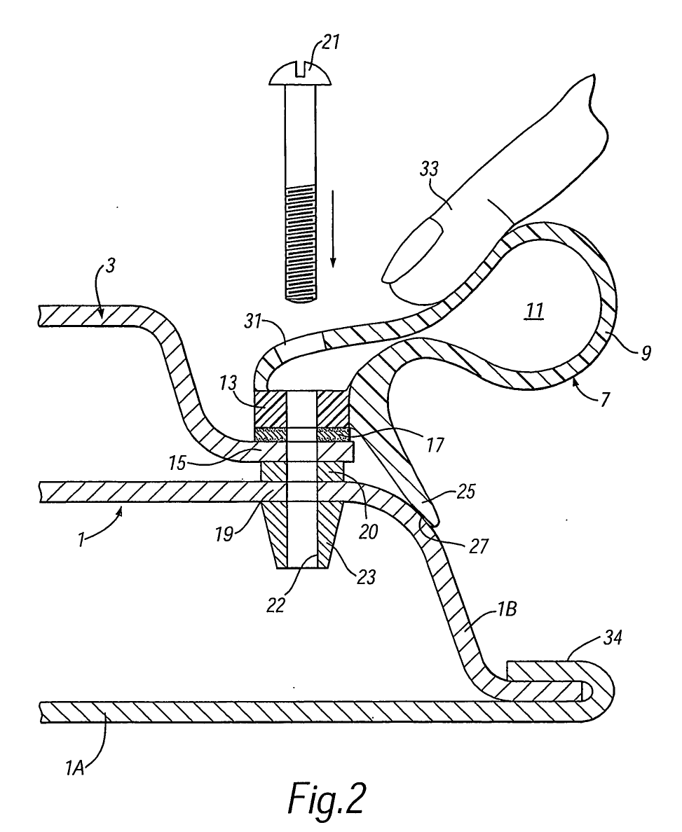

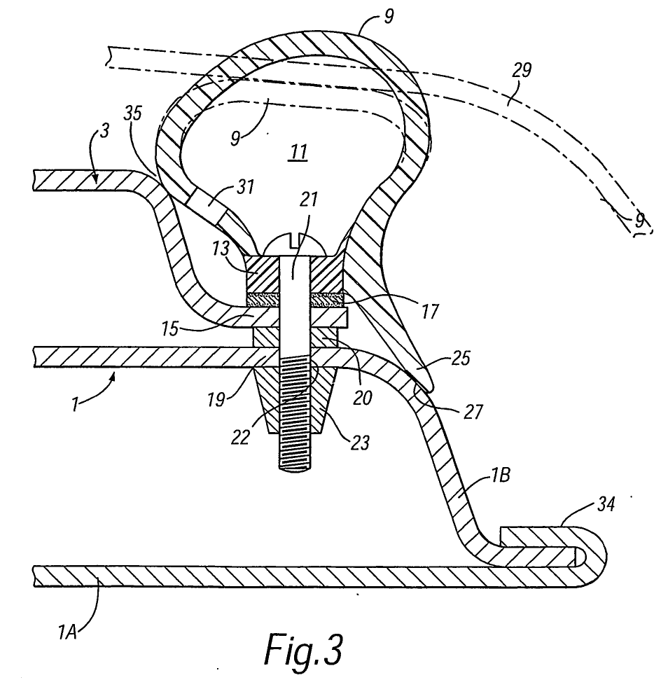

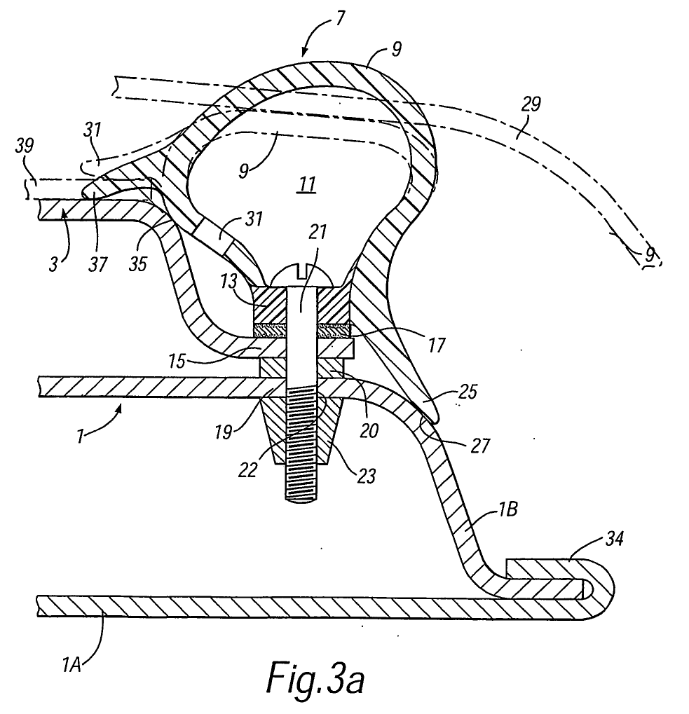

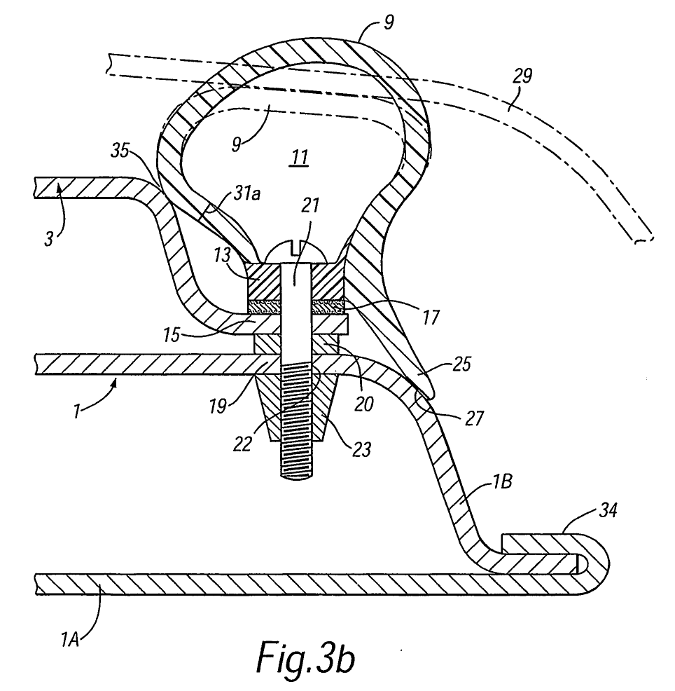

FIGS. 2 and 3 show a first embodiment of a seal 7 for fitting to a region of the door where the outer 1 and inner 3 parts of the door are connected together. The seal 7 provides a seal between the door and the door frame 29 formed in the vehicle body (shown by dashed lines in FIG. 3). For example, the seal 7 may provide a weather-proof seal around the door to prevent moisture entering the interior of the vehicle, and also serve to minimise noise such as wind noise entering the car when the car is being driven.

In addition to insulating the interior of the vehicle from moisture and noise, the seal 7 also functions to conceal from view the point at which the outer 1 and inner 3 parts of the door meet.

The seal 7 comprises a tubular member 9 defining a hollow interior 11 (best seen in FIG. 3). The seal 7 may be formed of any suitable flexible material, such as rubber or certain plastics and thermoplastic elastomers, as will be well known to those skilled in the art. The seal 7 comprises a base portion 13 which is generally planar and is configured to overlie a generally flat terminal portion 15 of the inner part 3 of the door. In this embodiment a double-sided adhesive tape 17 is interposed between the base portion 13 of the seal 7 and the terminal portion 15 of the inner door part 3. The double-sided adhesive tape 17 fixes the base part 13 to the terminal portion 15.

The terminal portion 15 of the inner door part 3 overlies a generally flat region 19 of the outer door part 1. Helically threaded screws 21 pass through apertures 22 formed through the base portion 13, the tape 17, the terminal portion 15 and the flat region 19 at spaced apart intervals around the periphery of the door (the seal 7—of which the base 13 forms a part—and the tape 17 extending substantially continuously or only partially around the periphery of the door). The screw 21 are secured in place by a corresponding helically internally threaded frusto-conical retaining member 23 which includes a cylindrical extension 20 extending towards the terminal portion 15.

The seal 7 comprises a concealing lip 25 extending from the right hand side (as seen in the Figures) of the base 13 and which meets the inner part of the car door 1 at meeting point 27. The concealing lip 25 is held against the meeting point 27 by means of its own resilience. The concealing lip 25 conceals from view of the user of the car the point at which the outer part 1 and the inner part 3 of the door are connected together, thereby providing the door as a whole with a “cleaner” and more visually appealing overall appearance. The lip has other advantages, including reducing or preventing dirt and moisture entering the space between the outer door part 3 and the inner door part 1. The tubular part 9 of the seal 7 conceals the screws 21.

When the car door is closed the door frame 29 formed in the car body frame (shown by dash lines in FIG. 3) compresses the tubular portion 9 of the seal 7 to provide an effective seal between the door and the door frame 29. The distortion of the tubular part 9 when the door is closed is shown by dash lines in FIG. 3.

FIG. 2 shows the means by which the screw 21 may be fitted in place in accordance with the first embodiment of the invention. A hole 31 is formed in the tubular part 9 of the seal near 7 to the base portion 13 at a position such that when the tubular part 9 of the seal 7 is pulled away from the inner part 3 of the door by a fitters finger 33 (or by a suitable tool) as shown in FIG. 2 the hole 31 overlies the aperture 22 formed through the base 13, the tape 17, the terminal portion 15 and the flat region 19. The alignment of the hole 31 with the aperture 22 allows the fitter to insert the screw 21 into the aperture so that its screw thread can cooperate with the corresponding screw thread on the retainer 23. Conveniently, the retainer 23 may be fixed in place in alignment with the aperture 22 by means of adhesive, or the operator may position the retainer 23 in the appropriate position to allow coupling to the screw 21.

As can be seen in FIGS. 2 and 3, the outer part 1 of the door comprises a generally planar outer part 1A which forms the exterior surface of the car door as seen from outside the vehicle. Although this part will be generally planar, it will be profiled to provide the desired aerodynamic and styling characteristics of the car. Where the part 1A of the outer part 1 of the door meets a coupling part 1B, the part 1A is folded over and clamped against the periphery of part 1B at point 34 to securely fit together the parts 1A and 1B. Parts 1A and 1B may additionally or alternatively be welded (such as spot welded) to one another or may be coupled by a strong adhesive or sealant.

The arrangement of the seal 7 is such that it allows the simple fixing together of the outer part 1 and inner part 3 of the door, by means of the screw 21 passing through the hole 31 and the aperture 22, by simple operation of the fitter using his finger 33 to squeeze and compress the tubular part 9 of the seal 7 in the region of the aperture 22. After the screw 21 has secured the outer part 1 to the inner part 3 of the door by cooperation of its screw thread with the screw thread of the retainer 23 the fitter can remove their finger 33 which causes the tubular part 9 of the seal 7 to resile and take up the position shown in FIG. 3 where it abuts the inner part 3 of the door at point 35 and is positioned for pressing against the door frame 29 when the door is closed. The abutment of the tubular part 9 to the inner part 3 at point 35 conceals the aperture 31 from view and also prevents or reduces moisture and/or dirt from entering the space 11 within the tubular part 9 via the hole 31. The tubular part 9 returns to the sealing position shown in FIG. 3 by means of its own resilience.

In addition to clamping the inner part 1 to the outer part 3 of the door, the screw 21 also provides an additional force which secures the seal 7 to the door, augmenting the adhesive attachment provided by the tape 17. If desired or appropriate, the tape 17 could be omitted.

FIG. 3a shows a modification to the first embodiment of the invention in which a cosmetic lip 37 is integrally formed to extend from the left hand side (as shown in FIG. 3a) of the tubular part 9 of the seal 7. The cosmetic lip 37 is for fitting over a trim panel 39 (shown in dashed lines). When the trim panel 39 is present the cosmetic lip 37 overlies the trim panel 39 in the position shown by dash lines in FIG. 3a. The cosmetic lip 37 presses against the trim panel 39 by means of its own resilience. The trim panel 39 may be the panel fitted to the interior surface of the car door in a conventional manner which provides the desired internal appearance to the inside of the door to provide a visually pleasing appearance and one which matches the other interior fittings of the car such as the seat upholstery.

FIG. 3b shows a further modification to the first embodiment of the invention in which the hole 31 is replaced by an elongate slit or cut 31a in the tubular portion 9. The slit or cut 31a will normally be closed, with the opposite edges thereof abutting one another. When the tubular portion is deformed by the fitter's finger in order to insert the screw 21, the force applied to the resilient material of the tubular portion 9 causes the slit or cut 31a to open and allows the screw 21 to pass therethrough. Therefore, with the slit or cut 31a, the appearance of the tubular portion when it is deformed will be substantially identical to that shown in FIG. 2 because the slit or cut 31a will be opened by the applied force. When the tubular portion 9 is released, it will return to the position shown in FIG. 3b and the slit or cut 31a will close again due to the resilience of the material of the tubular portion 9.

The provision of a slit or cut 31a may be advantageous because this improves the strength of the tubular portion 9 and reduces the likelihood of dirt entering the hollow space 11 and possibly damaging the seal 7.

The seal 7 of the first embodiment may be formed of material of two different hardnesses, with the base portion 13 being formed of material which is harder than the tubular portion 9, and preferably also harder than the concealing lip 25 and the cosmetic lip 37 (if provided).

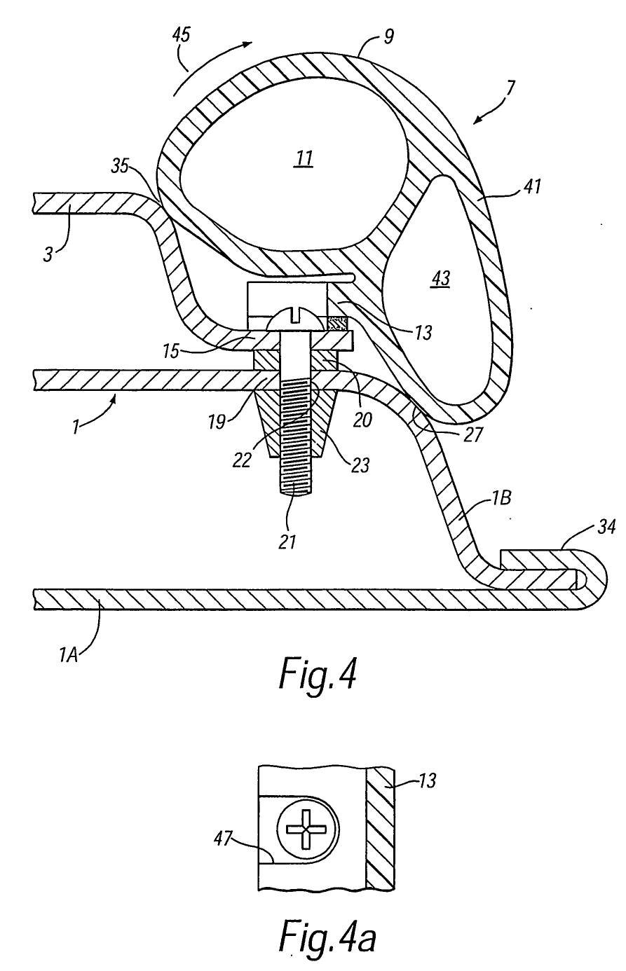

FIG. 4 shows a second embodiment of the invention in which the concealing lip 25 is replaced with a concealing additional tubular portion 41 defining a hollow space 43.

In this embodiment the base portion 13 of the seal 7 is coupled to the seal at one point around the tubular part 41 (in the embodiment the base portion 13 is integrally formed with the other parts of the seal 7, although this is not essential). By coupling the base portion 13 to the seal 7 at only one point, this allows the seal 7 to be pivotted around the point at which it is attached to the terminal portion 15 of the inner part 3 of the door, as indicated by arrow 45. This can be done by the fitter applying his finger to the appropriate part of the seal 7 and pulling the seal 7 in the direction of the arrow 45. This will also squeeze and distort the seal 7. Such pivotting of the seal 7 about the pivot point exposes the aperture 22 through the tape 17, the inner part, the outer part 1 and the retainer 23 and allows the screw 21 to be fitted in this aperture 22, thereby securing the inner part 3 to the outer part 1 of the door by cooperation of its screw thread with the corresponding screw thread of the retainer 23. In this embodiment the screw head may lie against the surface of the terminal portion 15 of the inner part 3 or may preferably clamp and compress the portion of the adhesive tape 17 around the periphery of the aperture to the terminal portion 15. In this embodiment the seal 7 is secured in place by means of the adhesive tape 17, and not also by means of the screw 21. As shown in FIG. 4a, recess 47 is formed in the base portion 13 of the seal 7 at the point which corresponds to the location of the aperture 22 through the inner 3 and outer 1 parts of the door, etc. at appropriate points around the periphery of the door to allow the passage of the screw 21. The recess 47 may be extended along the longitudinal direction of the seal 7 to allow for easier positioning around the screws 21.

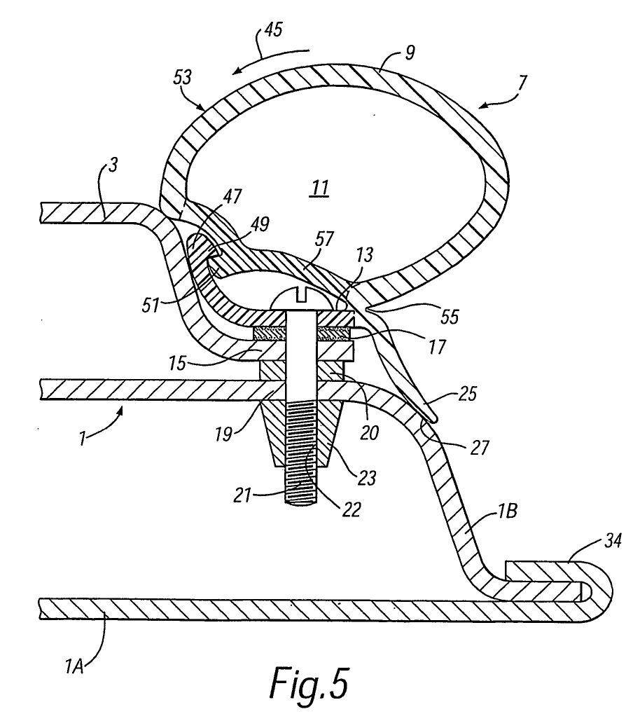

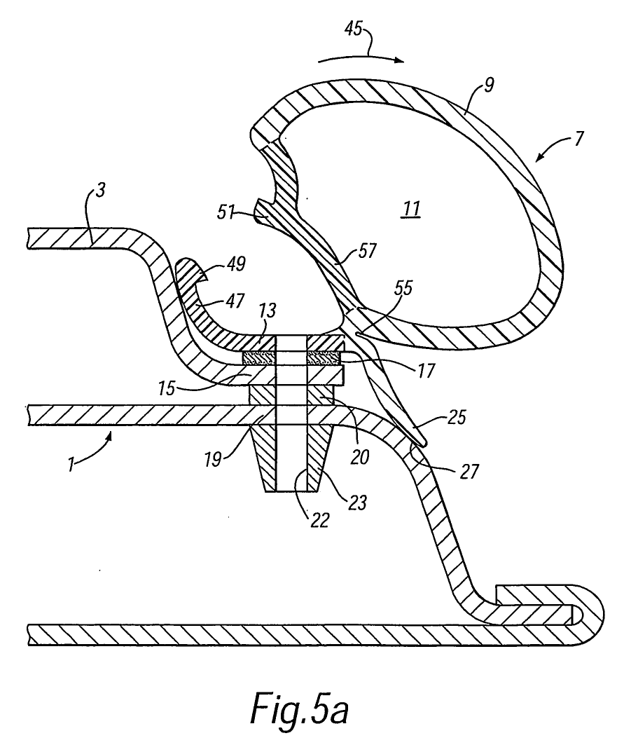

FIG. 5 shows a third embodiment in which the seal 7 includes an extension 47 to the base 13 which follows the contour of the inner door part 3 and forms a ridge 49 against which an engagement lip 51 extending from the tubular portion 9 of the seal 7 abuts. The ridge 49 and the engagement lip 51 are formed of material which is rigid relative to the remainder of the tubular portion 9, which allows cooperation of the ridge 49 and the lip 51 to hold the tubular part of the seal 9 in the position shown in FIG. 5 in normal use.

However, as shown in FIG. 5a, to allow fitting of the screw 21 through the aperture 22 in the inner and outer door parts 1 and 3, etc. the resilience of the tubular part 9 (including the lip 51) and the base 13 (including the extension 47) allows the decoupling of the ridge 49 from the lip 51 by pressing the tubular part 9 in the region indicated by arrow 53. Such pressing can be performed, for example, by the pressure of the fitter's finger. When the ridge 49 and the lip 51 are disengaged movement of the tubular part 9 in the direction of arrow 45 causes the tubular part 9 to pivot with respect to the base portion 13 about pivot point 55. When the tubular part 45 is pivotted in the direction of arrow 45 this allows access to the aperture 22 in order that the screw 21 may be fitted to connect the outer 1 and inner 3 door parts together.

When the screw 21 has been fitted in place, the tubular part 9 pivots back in the direction opposite to arrow 45 and the ridge 49 and the lip 51 again interlock to secure the tubular part 9 of the seal in the position shown in FIG. 5 so that it can provide effective sealing against the frame 29. In the position shown in FIG. 5 the head of the screw 21 is concealed.

The tubular part 9 of the seal (including the abutment lip 51) may be integrally formed and may comprise a relatively rigid region 57 shown by a different hatching pattern. This tubular portion 9 may be integrally formed with the base portion 13 (including the ridge 49) or may be formed separately therefrom and coupled thereto. The base portion 13 is of material that is rigid compared to the main region of the tubular part 9, and may have a similar rigidity to the region 57 of the tubular part 9.

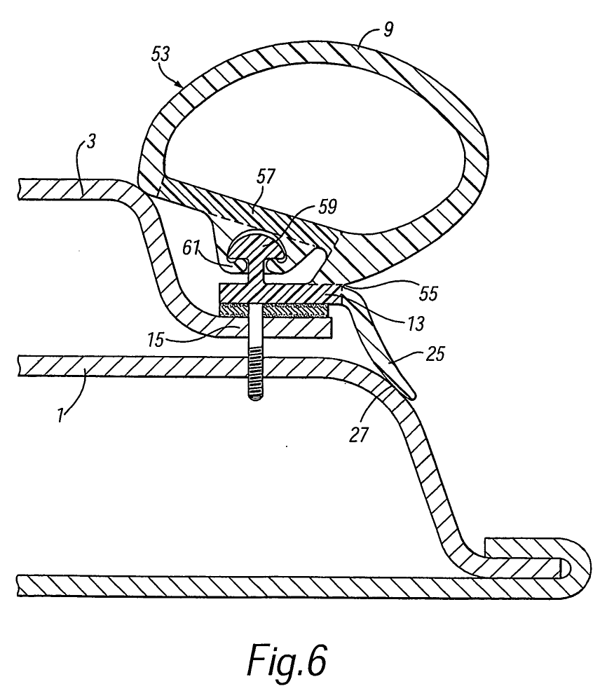

FIG. 6 shows an alternative arrangement in which the ridge 49 and the lip 51 are not provided but where releasable securing of the tubular part 9 in the position shown in FIG. 6 is provided for by a generally T-shaped (or mushroom shaped) protrusion 59 from the base portion 13 which cooperate with resilient lip 61 extending from the region 57 and located for cooperating with the protrusion 59 such that the lip is distorted when the protrusion 59 is pushed against the lip 61, after which the lip 61 resiles and clamp the tubular part 9 in the position shown in FIG. 6. Lip 61 may be formed of material which is soft relative to the material of the protrusion 59 and the region 57 of the tubular part 9, and may, for example, be formed of material of the same softness as the main part of the tubular portion 9.

The protrusion 59 may be extruded with the seal 7.

The protrusions 59 may be circular or eliptical when viewed from overhead in which case the lips 61 may have an annular configuration. Protrusions 59 and corresponding annular lips 61 may be positioned at spaced apart intervals around the periphery of the door sufficiently close together to allow the tubular part 9 of the seal to be maintained in the position shown in FIG. 6. Between any pair of protrusions 59 and corresponding lips 61 one or more screws 21 may be provided to provide the desired securing together of the outer part 1 and inner part 3 of the door. Recesses in the seal may be provided to accommodate the screws 21.

In a similar manner to the arrangement shown in FIGS. 5 and 5a, the tubular part 9 in FIG. 6 may be pivotted with respect to the base portion 13 by pressing the tubular part 9 in the region 53, which results in uncoupling of the lip 61 from the protrusion 59, due to the resilience of the lip, and allows pivotting of the tubular part 9 about the pivot point 55 to allow access to the apertures to insert and remove the screws 21.

The concealing lip 25 may be integrally formed with the other parts of the seal 7 and may be of a material which is of a similar softness to the main part of the tubular part 9.

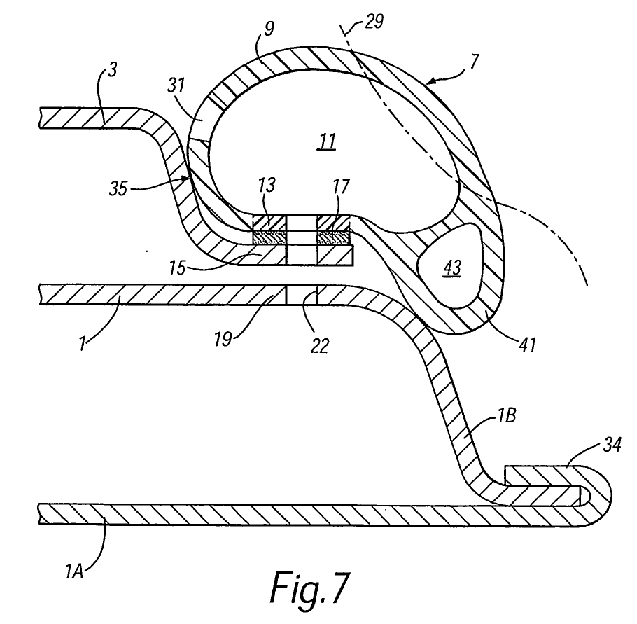

FIG. 7 shows a fourth embodiment which is similar in principle to the embodiment shown in FIGS. 2 and 3. The concealing lip 25 is replaced by a concealing tubular portion 41 similar to that shown in FIG. 4. A hole 31 is provided in the tubular part 9 to allow the securing screw 21 (not shown) to be fitted in the aperture 22 when the tubular part 9 is appropriately distorted by the fitter. The base portion 13 of the seal 7 is formed of relatively hard material to effectively locate the seal 7 by means of adhesive tape 17 onto the terminal portion 15 of the inner door part 3. In this embodiment the tubular part 9 follows more closely the contour of the inner door part 3 and abuts against the inner door part 3 over a greater region 35 than in the FIG. 2 and 3 embodiment. This improves sealing when the arrangement of the door and the door frame 29 (shown by dash lines in the Figure) are arranged to compress the seal 7 in a region lying generally opposite to the region 35.

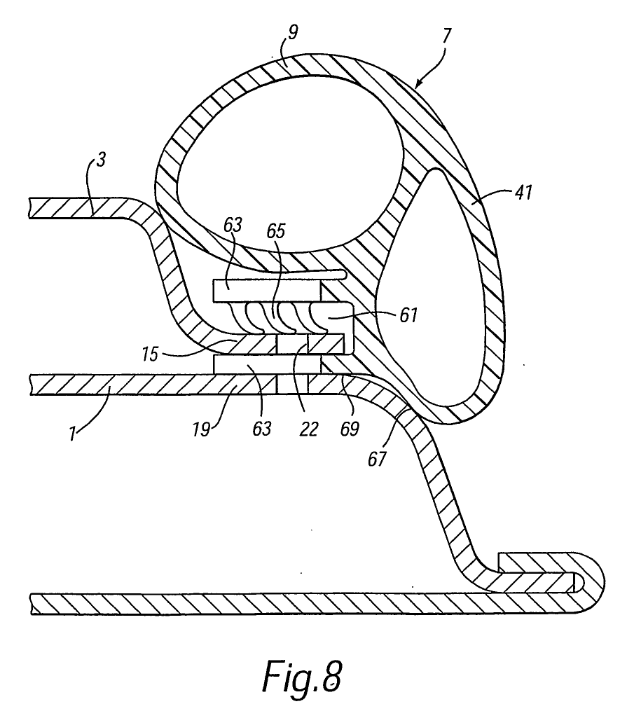

FIG. 8 shows a fifth embodiment of the invention in which the outer 1 and inner 3 door parts are coupled together by a series of appropriately spaced screws (not shown) in the apertures 22 around the periphery of the door. In the FIG. 8 embodiment the seal 7 has a U-shaped channel portion 61 in place of the base portion 13. The U-shaped channel portion comprises two oppositely disposed generally parallel walls 63 and 63′ extending from tubular part 41. The wall 63 is provided with a series of recesses positioned to accommodate the screws fitted and spaced apart at intervals around the door periphery and which allow the relevant wall 63 to pass between the adjacent screws 21 and lie between the terminal portion 15 of the inner door part 3 and the flat region 19 of the outer door part 1. The opposite wall 63′ of the channel 61 overlies the opposite surface of the terminal portion 15 and secures the seal 7 in position by means of gripping lips 65. Of course, gripping lips 65 may be provided which extend from both walls 63 and 63′. The tubular portion 41 presses against the outer door part 1 at point 67 and the lower wall 63 presses against the outer door part 1 at point 69 to prevent or reduce moisture and dirt passing into the space between the outer door part 1 and the inner door part 3.

In the FIG. 8 embodiment the outer and inner door parts 1 and 3 are secured together by the series of screws prior to the seal 7 being secured thereto by pushing the U-shaped channel 61 of the seal over the terminal portion 15 of the inner door part 3.

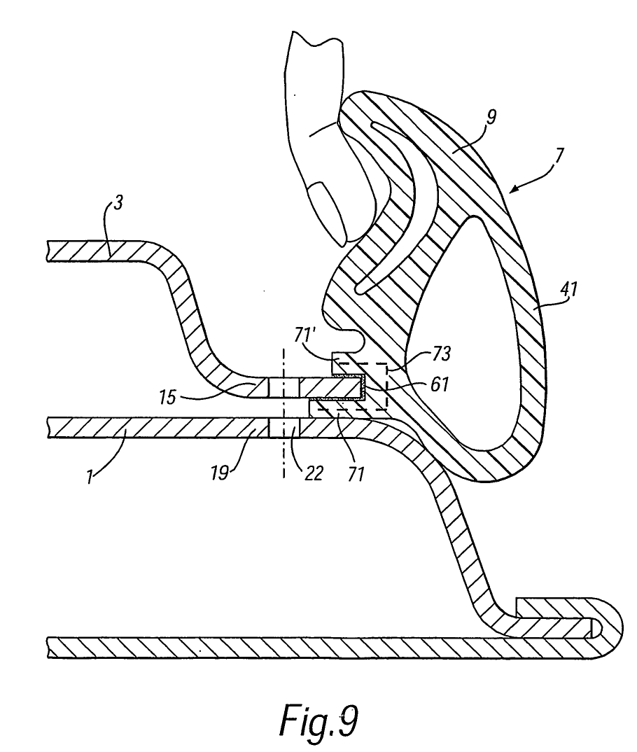

In an alternative arrangement shown in FIG. 9 a U-shaped channel 61 is also formed. However, the first wall 71 and the second wall 71′ of the channel are shorter than the walls 63 and 63′ of the channel 61 shown in FIG. 8. The first wall 71 is longer than the second wall 71′ and extends almost to the periphery of the aperture 22. A generally U-shaped carrier 73 (formed of metal or any other suitable rigid material) may be provided embedded within the material of the seal 7 in the region of the U-shaped channel 61 to provide additional strength in this region and a gripping force tending to clamp the channel 61 of the seal 7 to the terminal portion 15 of the inner part 3 of the door.

The seal 7 may be fixed to the door by the clamping action of the channel 61 only, or this may be augmented by an adhesive provided in the channel 61 and/or between the wall 71 and the outer door part 3 where the wall 71 abuts the outer door part 1.

When the seal 7 is fitted to the inner door part 3, the screws 21 (not shown) may be fitted into the aperture 22 to secure the outer door part 1 and the inner door part 3 together by compressing the tubular part 9 of the seal in the manner shown. When such a compressive force is not applied, the tubular part 9 has a configuration substantially as shown in FIG. 8 to provide effective sealing against the door frame.

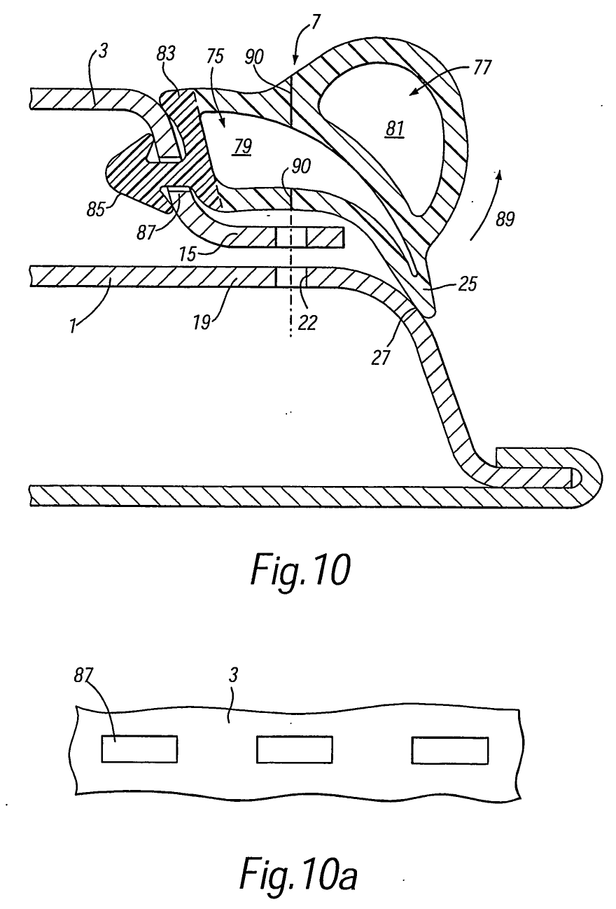

FIG. 10 shows a further embodiment in which the seal has a different configuration. A first tubular part 75 is of generally triangular (in section) configuration and from which a second tubular part 77 extends which is of generally semi-circular (in section) configuration, the two tubular parts defining respective hollow spaces 79 and 81. The generally triangular tubular part 75 includes a portion curved downwardly to form concealment lip 25. The base 83 of the generally triangular tubular part 75 is formed of material which is rigid relative to the remainder of the triangular part 75 and also the semi-circular part 77. The base portion 83 lies against a wall of the inner door part 3 which is generally perpendicular to the terminal portion 15 through which the fixing screw 21 (not shown) passes. The base portion 83 comprises a protrusion 85 having a similar configuration to the protrusion 59 shown in FIG. 6. This protrusion 83 is formed to cooperate with an aperture 87 formed in the inner door part 3 such that the protrusion 85 may be pushed through the aperture 87, which resiliently deforms the protrusion 85, after which the protrusion 85 resiles and serves to clamp the base portion 83 against the inner door part 3, thereby securing the seal 7 in position.

The screws 21 may be fitted by lifting the seal 7 in the direction shown in arrow 89 to reveal the aperture 22.

Alternatively, the screws may be fitted through slits 90 formed in the tubular part 75, which can be opened in a similar manner to the slits 31b of FIG. 3b

The semi-circular portion 77 is pressed against the door frame (not shown) when the door is closed to provide an effective seal against moisture and noise ingress into the interior of the car.

The protrusions 85 and corresponding apertures 87 (as shown in FIG. 10a) may be formed at regular spaced apart intervals to provide the necessary security of fixing of the seal 7. Of course, the protrusions 85 and apertures 87 could be replaced by cooperating clips or any other suitable form of attachment means.

Conveniently, the seal 7 would be a single integrally formed part comprising the first and second tubular parts 75 and 77, the base portion 83, the concealment lip 25 and the protrusions 85. The protrusions 85 may be formed as a continuous protrusion along the entire length of the seal 7. Selective parts of this continuous protrusion may be cut away in order to provide the desired discrete protrusions 85 described above.

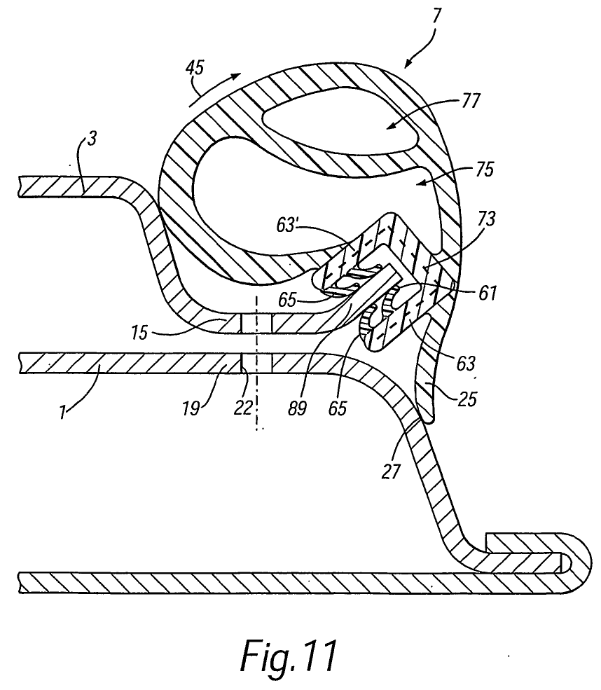

FIG. 11 shows a seventh embodiment of the invention. In this embodiment first 75 and second 77 tubular portions are also provided (although they have a differend shape to the FIG. 10 embodiment). In this embodiment a U-shaped channel 61 is integrally formed of relatively rigid material extending from the tubular part 75 and the concealment lip 25. Opposite walls 63 and 63′ of the channel 61 each have a plurality of gripping lips 65 integrally formed therefrom to secure the sealing position on a flange extension 89 of the terminal portion 15. The flange extension 89 of the terminal portion 15 of the inner door part 3 is bent upwardly away from the outer door part 1 to increase the distance between the respective inner and outer door parts 1 and 3. This allows the U-shaped channel to have a greater width which allows lips 65 to be formed extending from both of the walls 63 and 63′.

In the FIG. 11 embodiment, fixing screws may be fitted by pressing the seal in the direction of arrow 45. Alternatively, the seal can be fitted after the screws are in place.

As in the FIG. 9 embodiment, the channel 61 may have a reinforcing carrier 73 embedded in the material of the channel to improve the security of the fixing of the seal 7 to the inner door part 3.

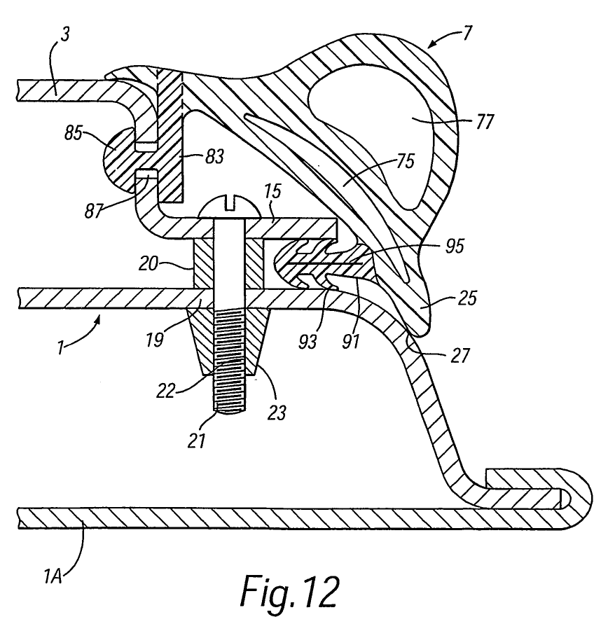

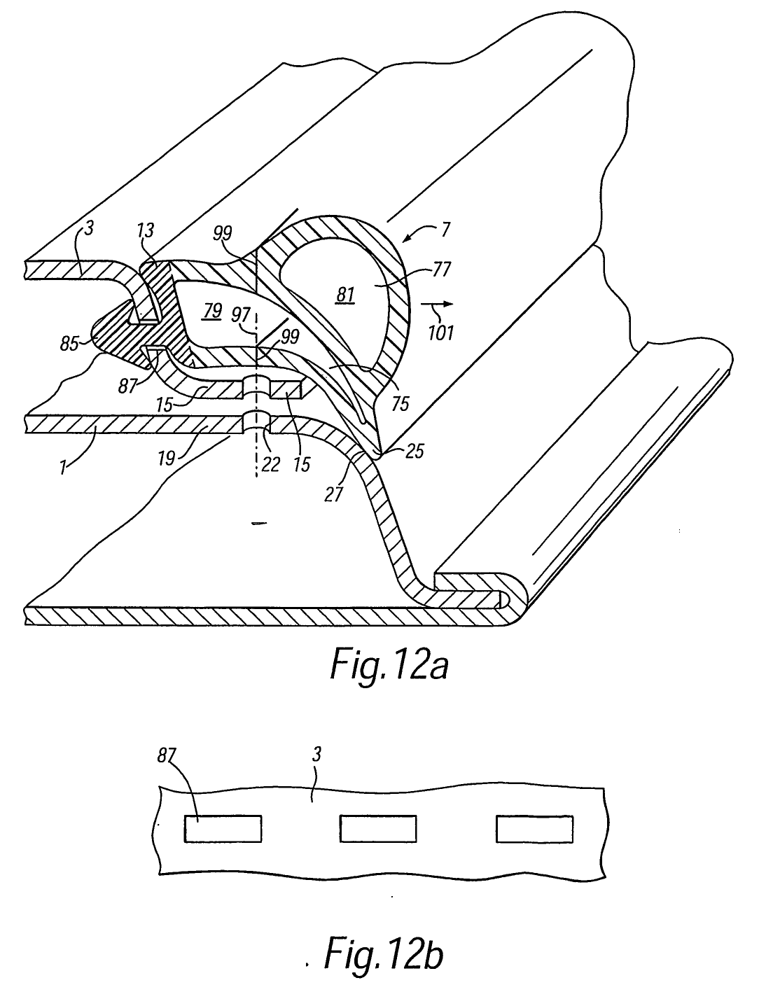

FIG. 12 shows a eighth embodiment in which the seal 7 comprises a base portion 83 similar to the base portion shown in the FIG. 10 embodiment from which a protrusion 85 extends through an aperture 87 also similar to the FIG. 10 embodiment. The first tubular portion 75 is smaller than the tubular portion described in the FIG. 10 embodiment. Extending from the first tubular portion 75 is a male member 91 from which a series of ridged portions 93 extend. The male member 91 is pushed between the outer door part 1 and the inner door part 3 after these parts have been coupled together by the fixing screws 21. The ridges 93, in combination with the protrusions 85 hold the seal 7 in position. A planar rigid carrier 95 may be provided in the male member to provide the desired rigidity to improve the security of the fixing of the seal 7. The male member 91 may be formed continuously around the seal 7, or at discrete intervals.

FIG. 12a shows an alternative embodiment in which the first tubular portion 75 has a configuration similar to the FIG. 10 embodiment. However, in the FIG. 12a embodiment the walls of the first tubular part portion 75 are cut through along the axis 97 of the fixing screw 21 (not shown) to form a slit 99 in each of the walls. When it is desired to fit a fixing screw 21, the seal 7 is pulled in the direction of arrow 101 which, because the base 13 is fixed in position by protrusions 85, opens the slits 99 and allows the screw to pass through the thus formed openings. When the screw has been fitted in position the seal is released and the slits 99 once again close due to the resilience of the material of the seal 7.

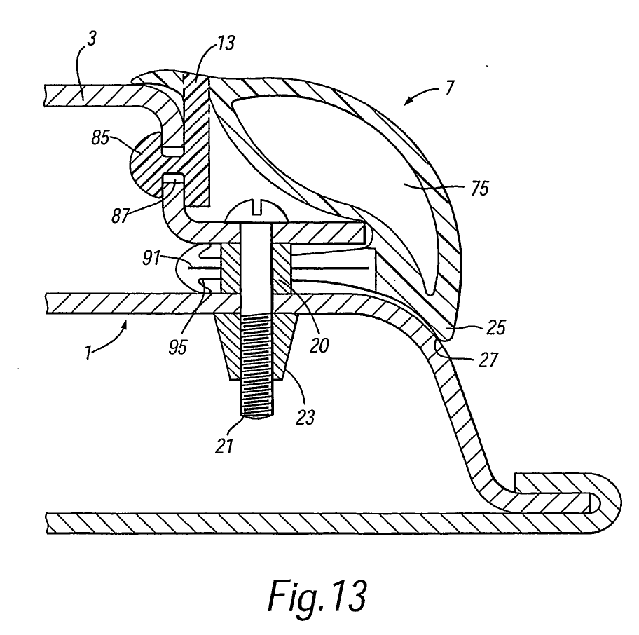

FIG. 13 shows a variation on the FIG. 12 embodiment in which only a single tubular portion 75 is provided. The male member 95 is longer than the male member 95 in FIG. 12 embodiment and is positioned to pass between adjacent fixing screws 21 to fix the seal 7 by being clamped between the outer door part 1 and the inner door part 3.

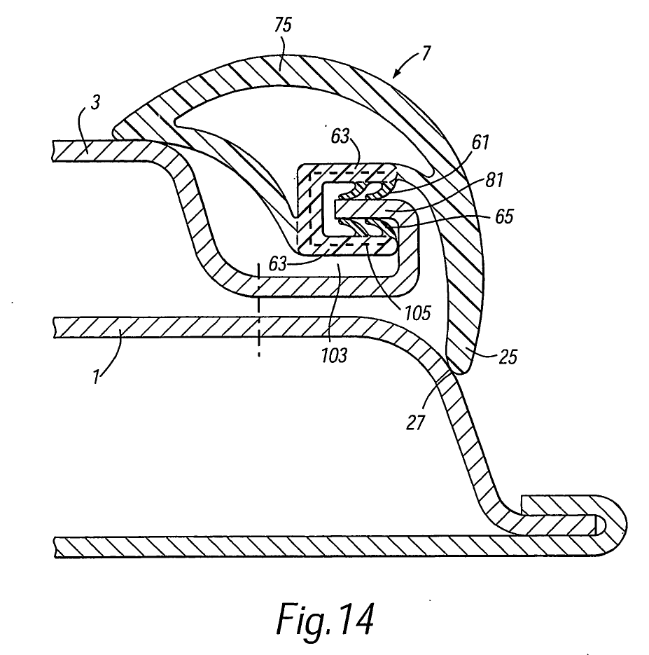

FIG. 14 shows a variation of the FIG. 11 embodiment. In the FIG. 14 embodiment the flange extension 89 is further extended to form a U-shaped channel 103 by bending the flange extension 89 over itself. A corresponding U-shaped channel 61 extends from the single tubular portion 75 of the seal 7 and clamps to the flange extension 89 to secure the seal 7 in position. An L-shaped carrier 105 may be embedded within the material of the channel portion 61 to improve the clamping force.

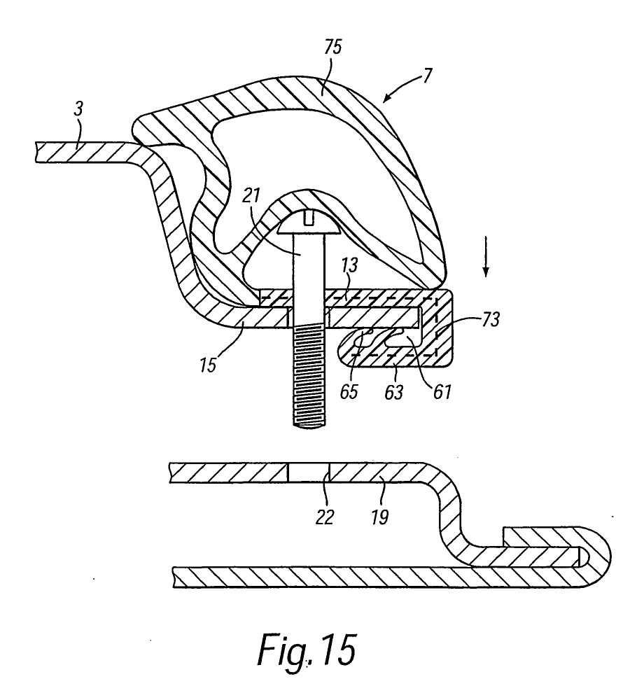

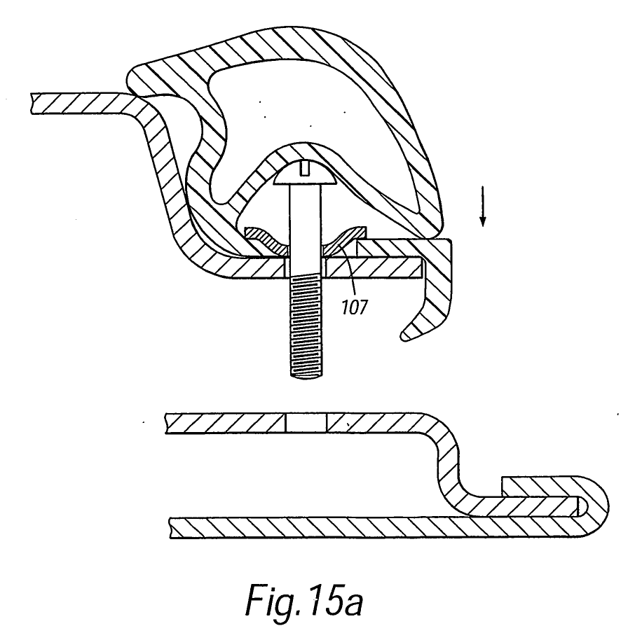

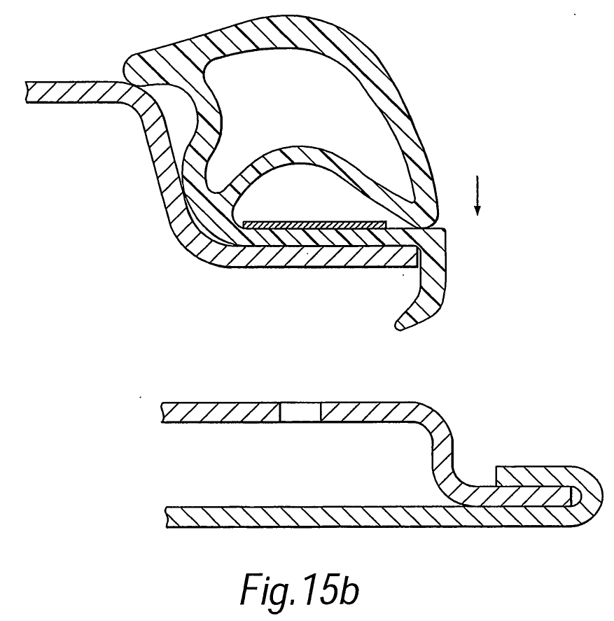

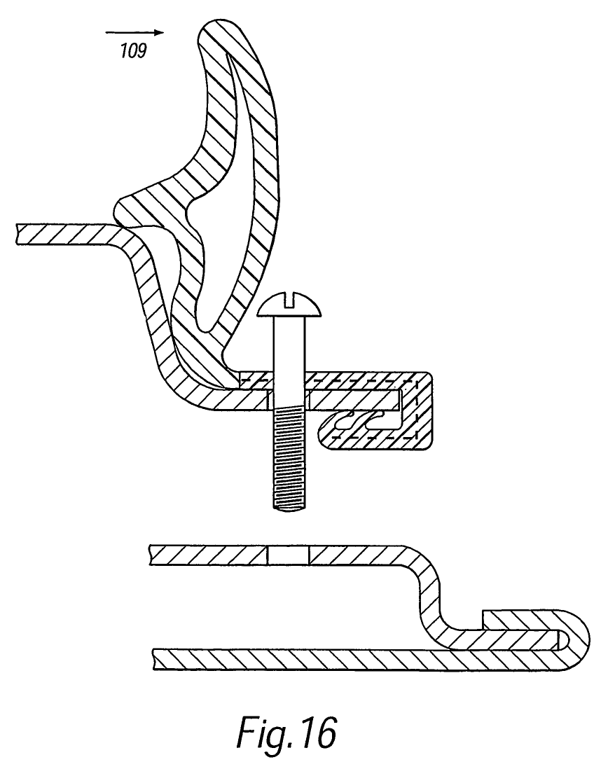

FIGS. 15 and 16 show a further embodiment in which the fixing screws 21 are carried by the seal 7 prior to assembly of the seal 7 to the inner door part 3. The seal 7 comprises first tubular portion 75 for pressing against the door frame. Extending from the base 13 of the seal 7 is a U-shaped channel 61 which may have embedded within it a rigid metal carrier 73. The screw is fitted in one wall of the channel 61, by means of the carrier 73. The screw 21 may alternatively or additionally be fitted in the inner panel 3. The channel 61 may have gripping lips 65 extending from one of its walls 63 to allow the seal 7 to be secured to the inner door part 3. When the seal 7 has been secured in this manner the inner door part 3 and the outer door part 1 can be brought together with the screws held in the appropriate positions and the screw may then be used to secure together the inner door part 3 and the outer door part 1. The diameter of the apertures 22 for the fixing screws 21 may be slightly smaller than the diameter of the screws 21 to assist in correctly positioning the screws 21.

FIGS. 15a and 15b show a variation of the FIG. 15 embodiment in which a generally disc shaped metal insert 107 is positioned around each of the apertures 22 for the fixing screws 21. The disc shaped inserts 107 clamp the base portion 13 of the seal 7 in position when the screws 21 are tightened.

FIG. 15a is a partial cross-sectional view taken at a position where one of the fixing screws 21 is located. FIG. 15b is a cross-sectional view taken at a different position around the periphery of the door. At this position the fixing screw 21 is not present although the metal insert 107 can be seen.

The seal may be moved from the position shown in FIG. 16 to that shown in FIGS. 15, 15a and 15b by being pushed by the fitter's finger, for example, in the direction of arrow 109 until the seal occupies the position shown in FIGS. 15, 15a and 15b. Only gentle pressure (or a low pressure impulse) needs to be applied by the fitter.

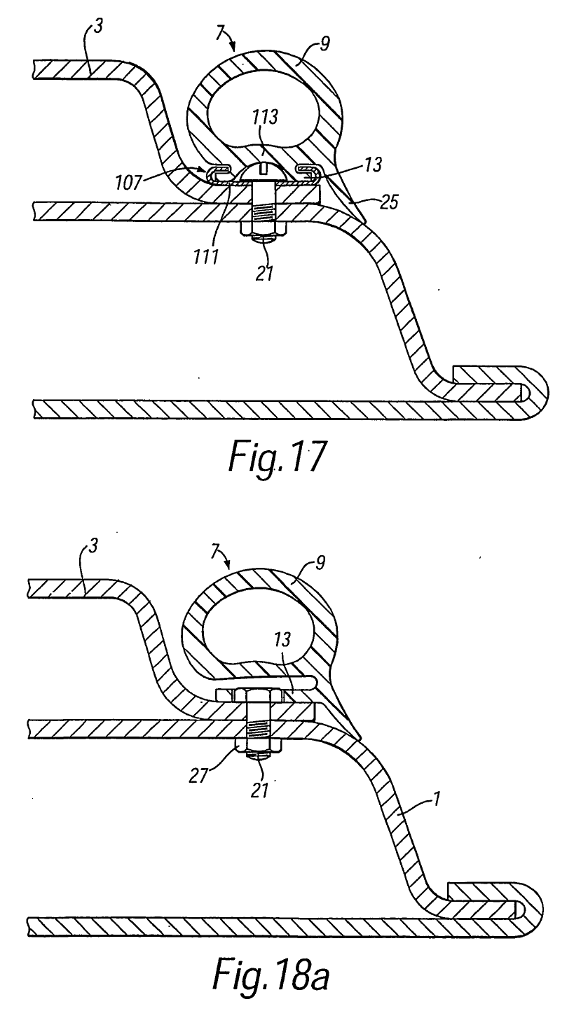

FIG. 17 shows variation on the 15a, b embodiment of the invention where the metal insert 107 is modified to have a generally C-shaped cross section having a main generally planar part 111 which lies against the inner door part 3 and is fixed thereto by fixing screw 21. The seal 7 has a base portion 13 which is generally planar in configuration and is coupled to the tubular portion 9 by means of a stem 113, these respective parts of the seal 7 being integrally formed together with the concealing lip 25.

The seal 7 is,held in place when its base 13 passes into the C-shaped metal insert 107. The base 13 may pass into the C-shaped metal insert 107 by any suitable method, such as resilient deformation of the base.

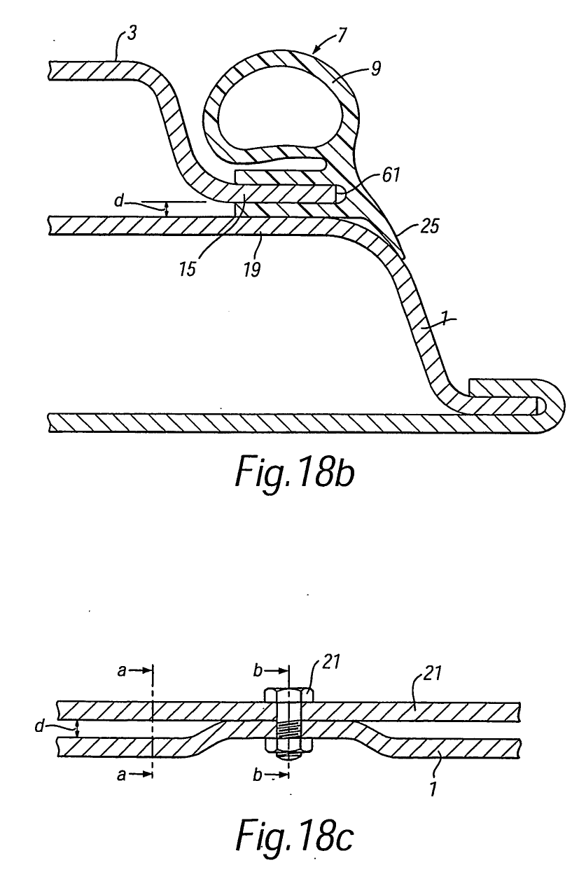

FIGS. 18a, b and c show a further embodiment. FIG. 18c is a side elevation of the periphery of the door, showing the outer part 1 and the inner part 3. FIGS. 18a and 18b are cross sections taken along the lines B-B and A-A respectively shown in FIG. 18c. At the point around the periphery of the door shown in FIG. 18a the base 13 of the seal 7 is secured to the inner and outer parts 1 and 3 of the door by the fixing screw 21, which of course also serves to secure the inner and outer parts on 3 of the door together. At the position around the periphery of the door shown in FIG. 18b no fixing screw 21 is present. At this position the spacing between the flat region 19 of the outer door part 1 and the terminal portion 15 of the inner door part 3 is increased to a distance d and in this region the base part is extended so that a U-shaped channel 61 is formed which fits around the terminal portion 15 of the inner door part 3.

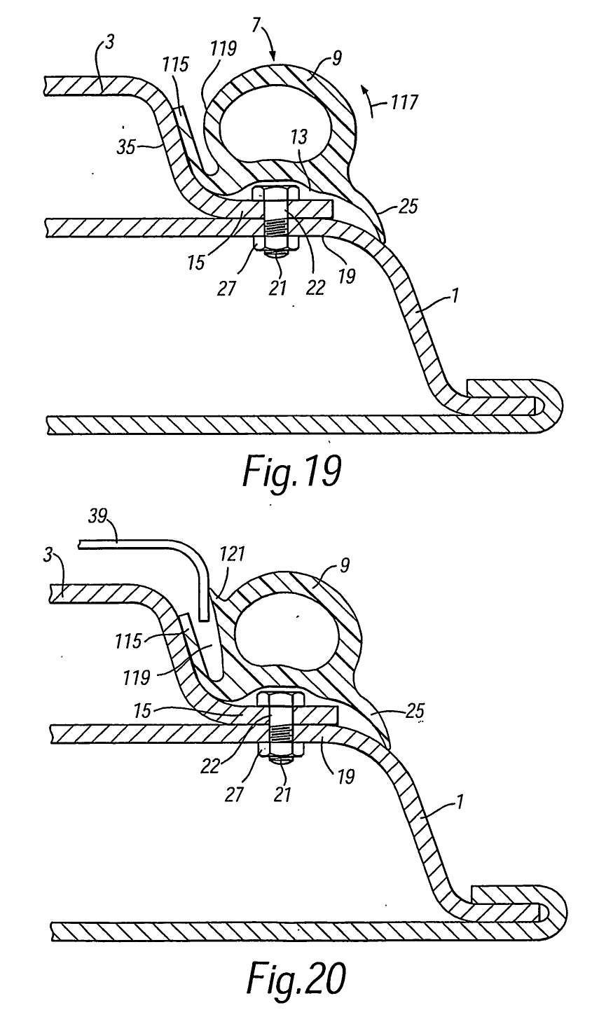

FIGS. 19 and 20 show a further embodiment of the invention in which the seal 7 is fixed to the inner door part 3 by a suitable adhesive applied at meeting point 35 between the inner door part 3 and the mounting lip 115 which extends integrally from the tubular portion 9 of the seal 7. This secures the seal 7 to the inner door part 3. Access to the aperture 22 to fit the fixing screw 21 thereto is provided by compressing and pivotting upwards in the direction of arrow 117 the seal 7. When the seal 7 is released it returns to the position shown in FIG. 19. When in the position shown in FIG. 19 a channel 119 is formed in the region where the mounting lip 115 extends generally parallel to the adjacent side wall of the tubular part 9. As shown in FIG. 20 the interior trim 39 of the inner part 3 of the door extends into the channel 1 19. The presence of the relatively rigid trim 39 in the channel 155 may serve to maintain the seal 7 in the position shown in FIGS. 19 and 20 where it covers the fixing screw 21. Additionally, because the trim 39 passes into the channel 119 this hides the edge of the trim 39 to provide a neat and pleasing visual appearance to the interior of the car. A cosmetic lip 121 may extend from the tubular part 9 to press against the outer surface of the trim 39 to further improve the appearance of the interior of the car and to more securely hold the seal 7 in the position shown in FIGS. 19 and 20.

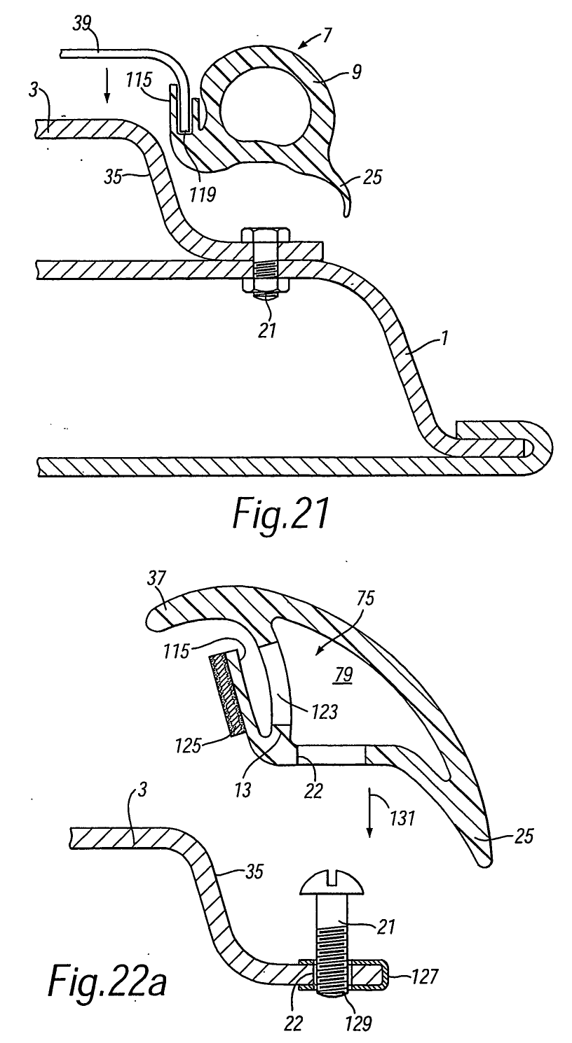

FIG. 21 shows an alternative arrangement to that shown in FIGS. 19 and 20. In the FIG. 21 embodiment the seal 7 is fixed in the channel 119 of the seal 7 by adhesive or any other suitable means prior to attachment of the seal 7 to the outer 1 or inner 3 parts of the door. The outer 1 and inner 3 parts of the door may be secured together by fixing screw 21. Subsequently, the trim 39 together with the seal 7 attached thereto are brought into position. The trim 39 is fixed in position to the inner part 3 of the door by any suitable conventional means, which also serves to secure the seal 7 in position on the inner door part 3. Additional adhesive may be applied at the meeting point 35 of the lip 115 to further secure the seal 7 to the inner door part 3. However, this additional adhesive is optional.

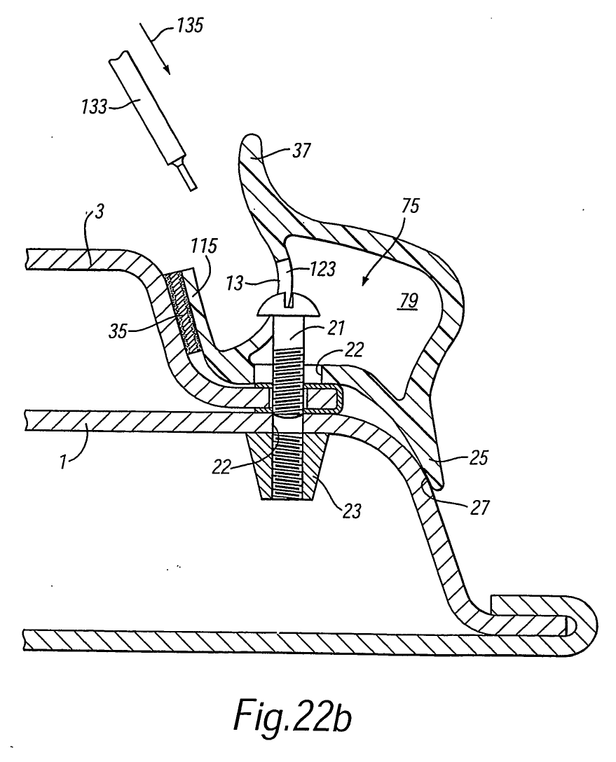

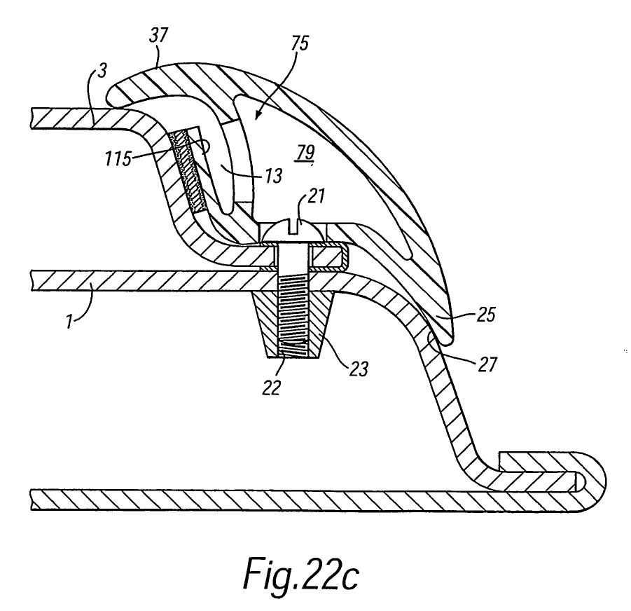

FIGS. 22A, B and C show a twelfth embodiment of the invention. In this embodiment the seal has a singule tubular part 75 which is of generally triangular (in section) configuration. The generally triangular part 75 includes the portion curved downwardly to form concealment lip 25. Extending from the opposite end of the tubular part 75 is a cosmetic lip 37 for fitting over a trim panel (not shown) mounted on the outer part 3 of the door. Also extending from the tubular part 75 is a mounting lip 115 which extends generally parallel to the base 13 of the seal. The concealment lip 25, cosmetic lip 37 and mounting lip 115 may be integrally formed with the tubular part 75.

The tubular part 75 has an aperture 22 formed therein for allowing a screw 21 to pass therethrough, in a similar manner to the other embodiments described above. A further aperture 123 is formed in the base 13 of the seal, the purpose of which will become apparent from consideration of FIG. 22B.

Connected to the mounting lip 115 at the side directed away from the base 13 is double-sided adhesive tape 125. The adhesive tape 125 may have a protection layer (not shown) formed over its exposed surface for convenience of handling. This protection layer is removed prior to fixing the seal to the inner part 3 of the door.

In this embodiment the screw 21 is pre-fitted to the inner door part 3 by means of a pre-fitting clip 127. The pre-fitting clip is generally U-shaped and includes an aperture 129 in each of the walls thereof. The aperture 129 is generally of smaller diameter than the aperture 22 formed in the outer door part 3. The aperture 129 in each of the walls of the clip 127 allows the screw to be fitted to the clip and held in the position shown in FIG. 22A. The tip of the screw 21 lies generally flush with the lower wall of the clip 127 prior to fitting the seal 3 to the inner door part 3. The seal is fitted to the inner door part 3 by bringing the seal towards the inner door part 3 in the direction of arrow 131. The screw 21 passes through aperture 22 in the seal, as shown in FIG. 22B. The adhesive tape 125 contacts the attachment point 35 on the inner door part 3 and secures the mounting lip 115 at this point. If required pressure may be applied at this point to increase the strength of the attachment between the mounting lip 115 and the inner door part 3.

The seal is then distorted by the fitter (for example using his finger or a suitable tool) into the position shown in FIG. 22B. This brings the apertures 22 and 123 generally into alignment in order that the head of the screw 21 can be accessed by the fitter's screwdriver 133 which is brought towards the screw 21 in the direction of arrow 135. The screwdriver 133 passes through the apertures 123 and 22 and engages the head of the screw 21, allowing the screw to be rotated and to couple the screw 21 to the retaining means 23 by means of their cooperating screw threads. The screw 21 thereby secures the inner door part 3 to the outer door part 1. When the screw 21 has been fully screwed into the retainer 23, the screwdriver 133 can be withdrawn through the apertures 22 and 123 and the pressure applied to the seal can be released. The seal then resiles and takes the position shown in FIG. 22C.

In the embodiments the seal or strip 7 is fixed to and seals around a car door having a frame for a window. It should be appreciated that the door may not include a window frame (or the seal may only be attached around a part of the door not including a window frame). Further, the invention is applicable to any closure member. For example, the seal could be applied around the periphery of a sunroof at the region where the glass panel of the sunroof meets the metal frame of the sunroof.

In all the embodiments the strip may be formed by extrusion or moulding.

Of course, any other suitable form of fixing could be used in place of screws 21.

1. A sealing strip for a closure member, the closure member comprising a first part and a second part, the strip being configured for mounting on the closure member to seal between the closure member and the frame of an aperture closed by the closure member and for obscuring from view a connection region between the first part and the second part of the closure member.

2. The strip of claim 1, wherein the connection region includes the region where means for connecting the first and second parts of the closure member are located.

3. The strip of claim 2, wherein the means for connecting the first and second parts comprises a screw or a clip.

4. The strip of claim 1 wherein the connection region includes the point at which the first and second parts of the closure member meet as would be viewed from the exterior of the closure member.

5. The strip of claim 4, wherein the strip comprises a lip or protrusion extending from the main body of the strip and abutting the closure member, the lip or protrusion being arranged such that it conceals the point at which the first and second parts of the closure member meet.

6. The strip of claim 1 wherein the sealing strip is configured for mounting at the peripheral edge region of the closure member.

7. The strip of claim 2, wherein the strip is configured such that the means for connecting the first and second parts of the closure member may be applied when the strip is mounted on the closure member.

8. The strip of claim 7, wherein one or more apertures, cuts or slits are formed in the strip to allow the connecting means to pass therethrough for connecting the first and second parts of the closure member.

9. The strip of claim 8, wherein two of said apertures, cuts or slits are provided, and wherein the strip is resiliency deformable in order to bring a first of said apertures, cuts or slits into alignment with the second of said apertures, cuts or slits to allow the connecting means to be applied, and further wherein, after said resilient deformation, the strip resiles and the alignment of said two apertures, cuts or slits is lost.

10. The strip of claim 1 further comprising adhesive means for mounting the strip to at least said first part of the closure member.

11. The strip of claim 10, wherein said adhesive means comprises double-sided adhesive tape.

12. The strip of claim 2, wherein the connecting means further connects the strip to at least the first part of said closure member.

13. The strip of claim 1, comprising a tubular portion for pressing against the frame of the aperture closed by the closure member, the tubular portion containing relatively highly compressible material.

14. The strip of claim 13, wherein the said compressible material comprises air.

15. The seal of claim 13, wherein the tubular portion defines a hollow region and the apertures, cuts or slits formed in the seal form a passageway from the hollow area to the exterior of the tubular portion.

16. The strip of claim 1 further comprising a resiliently deformable lip for overlying a trim panel coupled to at least said first part of the closure member.

17. The strip of claim 2, wherein the strip comprises a base portion for attachment to at least the first part of said closure member, the base portion having a plurality of recesses formed therein to accommodate the connecting means.

18. The strip of claim 17, wherein the base is at least one of pivotable or tiltable with respect to the main body of the strip, and wherein said base and said main body have corresponding engagement formations for releasably coupling together the base and the main portion at first relative positions thereto, and for allowing disengagement of said engagement formations by the application of force to the strip to allow pivoting or tilting relative movement between the main portion and the base.

19. The strip of claim 18, wherein said pivoting or tilting, allows said connecting means to be applied.

20. The strip of claim 1, wherein the strip comprises a channel-shaped portion for coupling to a flange of at least the first part of said closure member.

21. The strip of claim 20, wherein said channel-shaped portion includes a relatively rigid channel-shaped embedded carrier.

22. The strip of claim 2, wherein the strip is configured to cooperate with a relatively rigid clamping member which locates the strip when said connecting means is applied.

23. The strip of claim 1, wherein the strip comprises a plurality of mounting formations formed at spaced apart intervals along the length of the strip.

24. The strip of claim 23, wherein the first and second parts of the closure member are configured to lie in closer proximity to one another at the regions where said spaced apart mounting formations are provided, the spacing between the first and second parts being increased at other regions.

25. The strip according to claim 1, including means for coupling the strip to a trim portion for mounting onto the first part of said closure member.

26. The strip of claim 2, wherein the strip is configured to have a first position in which it allows access to the connecting means and a second operative position in which it obscures the connecting means, the strip being movable from said first position to said second position by applying a pushing force thereto.

27. The strip of claim 2, wherein the connecting means are coupled to the closure member hi a mounting position prior to mounting the strip on the closure member, the connecting means being moved from said mounting position to a fixing position after said strip is mounted to said closure member.

28. The strip of claim 2, wherein the connecting means is mounted to the first part prior to mounting the strip on the second part.

29. The strip of claim 28, wherein the connecting means is mounted to the first part by a fixing part which locates the connecting means with respect to the first part.

30. The strip of claim 1, wherein the closure member comprises a vehicle door.

31. A closure member comprising first and second parts and means for coupling together the first and second parts, wherein a sealing strip is provided on the closure member to seal between the closure member and the frame of an aperture closed by the closure member and for obscuring from view a connection region between the first part and the second part of the closure member.

32. A closure member according to claim 31, wherein the connection region includes the region where means for connecting the first and second parts of the closure member are located, wherein the strip is configured such that the means for connecting the first and second parts of the closure member may be applied when the strip is mounted on the closure member, wherein one or more apertures, cuts or slits are formed in the strip to allow the connecting means to pass therethrough for connecting the first and second parts of the closure member, wherein two of said apertures, cuts or slits are provided, and wherein the strip is resiliently deformable in order to bring a first of said apertures, cuts or slits into alignment with the second of said apertures, cuts or slits to allow the connecting means to be applied, and further wherein, after said resilient deformation, the strip resiles and the alignment of said two apertures, cuts or slits is lost.

33. The closure member according to claim 31, wherein the first and second parts of the closure member are fixed together before the strip is attached.

34. A method of mounting a sealing strip to a closure member comprising first and second parts, the method including:
coupling together the first and second parts, and
mounting the seal on the closure member to seal between the closure member and the frame of an aperture closed by the closure member and for obscuring from view a connection region between the first part and the second part of the closure member,
wherein steps (1) and (2) are performed in any order.

35. The method of claim 34 wherein the connection region includes the region where means for coupling together the first and second parts of the closure member are located, wherein the strip is configured such that the means for coupling together the first and second parts of the closure member may be applied when the strip is mounted on the closure member, wherein one or more apertures, cuts or slits are formed in the strip to allow the coupling together means to pass therethrough for connecting the first and second parts of the closure member, wherein two of said apertures, cuts or slits are provided, and wherein the strip is resiliently deformed in order to bring a first of said apertures, cuts or slits into alignment with the second of said apertures, cuts or slits to allow the coupling together means to be applied, and further wherein, after said resilient deformation, the strip resiles and the alignment of said two apertures, cuts or slits is lost.
